(19) United States
(12) Patent Application Publication
(10) Pub. No.: US 2005/0102623 A1
(43) Pub. Date: May 12, 2005

(54) AV decoding/playing/copying system and related method for displaying a DBCS through an OSD

(76) Inventor: Yuan-Chang Chin, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,799

(22) Filed: Aug. 3, 2004

(30) Foreign Application Priority Data
Aug. 4, 2003 (TW) 092121273

(51) Int. Cl. G11B 27/00

(52) U.S. Cl. 715/716

(57) ABSTRACT

A method for presenting a double byte character on a display device of an AV decoding/playing/copying system utilizing an on-screen display function to update a frame of the AV decoding/playing/copying system. The method includes storing at least one type of video source files and DBCS files in a storage medium. The file system of the storage medium is accessed to receive the file name length of the video source file and the internal codes of each DBCS file in the storage medium. The physical location of the internal code of the required character in the storage medium is then calculated. A character corresponding to the internal code is then captured from a corresponding DBCS file according to the physical location. Finally, the original information of OSD is updated by the character to update a frame of the display device.

### BACKGROUND OF INVENTION

1. Field of the Invention

The present invention relates to an AV decoding/playing/copying system capable of presenting double byte character set (DBCS) with an on-screen display function and related method, and more particularly, to an optical system capable of presenting DBSC without any additional memory in the optical decoding system and related method.

2. Description of the Prior Art

An on-screen display (OSD) function plays an important role in electrical products. Generally, the OSD function provides users with interactive information, such as system settings and indexes, to directly set and control the system configuration. Common applications of OSD are used in personal computers and televisions for providing users with information to directly adjust parameters related to the frame.

Please refer to FIG. 1, which is a diagram of a video process system 500. The video process system 500 includes a processor 10, an OSD unit 20, a video decoder 30, a mixer 40, a read-only memory (ROM) 50, a dynamic random access memory (DRAM) 60, and an OSD buffer memory 70.

The processor 10 is capable of accessing data, such as compressed data, stored in a storage medium (not shown in FIG. 1). After the processor 10 receives video bit streams, the bit streams are transmitted to the video decoder 30 to be decoded by the video decoder 30. A decoded frame is temporarily stored in the DRAM 60 to renovate the original frame and then the original frame is transmitted to a display 80 for viewers to experience.

The ROM 50 stores a plurality of computer program codes used for initializing the video process system 50 and performing logic operations of video signal decoding. The OSD buffer memory 70 stores OSD information, including OSD headers, OSD bitmaps and figures where the coordinate, brightness, and color indexes of each pixel have been assigned to present OSD information on the display 80.

When a user starts the OSD function, an OSD button (not shown in FIG. 1) is used to control the processor 10. The OSD unit 20 accesses OSD information to generate an OSD frame. After the OSD frame is transmitted to the mixer 40, the OSD frame overlaps the original frame decoded by the video decoder 30 to generate a frame with OSD information.

Generally, the OSD information displayed on the frame of the display 80 is described by figures. However, it is also necessary to use text for auxiliary information. Therefore, there are related fonts stored in the ROM 50 for text sources. When displaying text, the OSD unit 20 accesses data from the ROM 50 through the processor 10. Due to the high price of the ROM 50, the ROM 50 only stores specific texts or characters (26 English letters, specific texts, symbols, etc.) to minimize memory capacity requirements of the ROM 50.

In another application of OSD, the program codes stored in the ROM 50 are used to access the file names and directories so that the user can view the files stored in the storage medium by an OSD instead of a personal computer. However, fonts stored in the ROM 50 are limited. Only file names generated by the specific characters stored in the ROM 50 can be shown to viewers. If the internal code system of non-phonetic language, such as Chinese, Korean, Japanese, etc., is used, more than one byte is needed to describe characters of the file name generated by the DBCS language system. The ROM 50 does not store all characters defined by the internal code system of double byte character sets. Therefore, some characters of file names cannot be shown correctly.

### SUMMARY OF INVENTION

It is therefore a primary objective of the claimed invention to provide an AV decoding/playing/copying system and method for presenting DBSC by an OSD function without any additional memory to solve the above-mentioned problem.

The claimed invention provides an AV decoding/playing/copying system having an OSD control device. The OSD control device is capable of accessing DBCS files in a storage medium and presenting DBCS on a display to update the frame of the display. The OSD control device includes an OSD buffer memory, a memory, and an OSD unit.

OSD information is stored in the OSD buffer memory. A processor of the AV decoding/playing/copying system is electrically connected to the memory. The processor is capable of accessing the file system of the storage medium, and calculating the file name length of the video source file in the storage medium. The OSD unit is electrically connected to the OSD buffer memory. The OSD unit accesses characters from font files through the processor according to internal codes. Finally, according to OSD information, the file name can be shown on the display by the OSD function so that the frame of the display is updated.

The claimed invention provides a method for presenting a file system by an OSD function. The method includes accessing a file system of a storage medium, calculating the file name length of a video source file in the storage medium, receiving the internal codes of the file name, calculating the physical locations of DBCS files of each internal code in the storage medium, capturing characters corresponding to each internal code according to the physical locations, and finally receiving characters from DBCS files according to each internal code so as to present characters of the file name on a display.

The AV decoding/playing/copying system of the claimed invention stores DBCS files in the storage medium. Therefore, all types of fonts can be stored without any additional memory. No matter which internal code system is used, after physical locations of each character are correctly calculated, characters corresponding to each internal code can be received from the storage medium and presented on the display. Therefore, file names for all types of internal code systems can be shown correctly.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a video processing system according to the prior art.

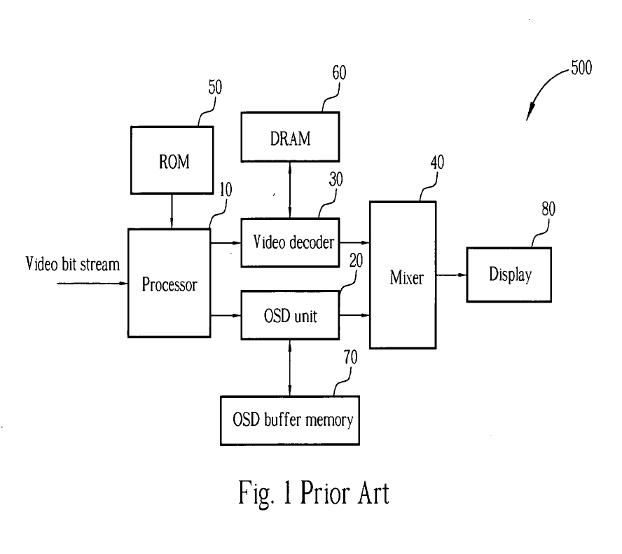

FIG. 2 is a diagram of the present invention presenting DBCS by an OSD function.

FIG. 3 shows a table of all traditional Chinese characters of the BIG 5 coding system.

FIG. 4 is a diagram of an OSD information structure.

FIG. 5 is a flowchart of the method of the present invention for presenting DBCS by the OSD function to update the frame of the display.

### DETAILED DESCRIPTION

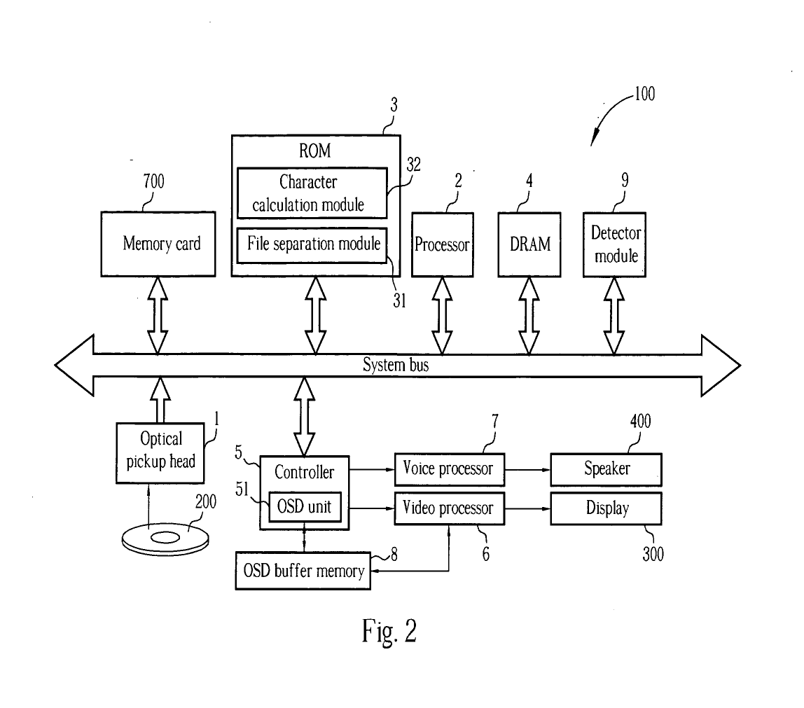

Please refer to FIG. 2. An AV decoding/playing/copying system 100 of the present invention is capable of presenting a file structure of a storage medium, such as directories, file names, and etc., on a display 30 by an on-screen display (OSD) function.

In this preferred embodiment, the storage medium is an optical disc 200, such as CD-R, CD-RW, DVD, DVD-R, DVD+R, DVD RAM, DVD-RW, DVD-RW, and etc. The storage medium has compressed video or audio files according to the MPEG specifications. The compressed files, for example, are video files having filename extension mpg, or audio files having filename extension .mp3. However, the present invention is not intended to be limited by the above. Other video files supported by a general video playback device, such as *.wmv, *.wma, *.wav, *jpg, *.mid, can be stored in the storage medium. In this embodiment, the present invention uses traditional Chinese characters for file name coding. Such file names therefore cannot be shown by the OSD function in the prior art decoding system. In addition, the MPEG specifications implemented in optical storage media have two types, MPEG-1 (ISO/IEC 11172), and MPEG-2 (ISO/IEC 13818), the former being implemented in VCD, and the latter being implemented in DVD or SVCD. Moreover, the storage medium can be a memory card 700. The present invention is implemented in both types of storage media.

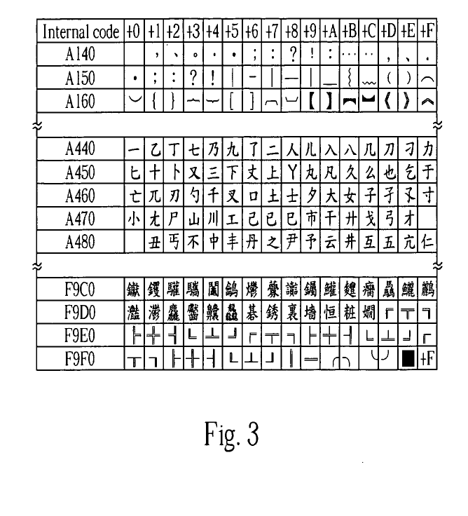

The storage media 200 and 700 have a plurality of font files of a double byte character set (DBSC), each font file corresponding to different internal code systems and having all characters assigned by the internal code system. The embodiment of the present invention only takes five types of font files for examples, but these examples are not to be construed as limiting. The exampled five types of font files are big5.24, gbk.24, unicode.24, ksc5601.24, and shift-jis.24, where big5.24 corresponds to the BIG 5 internal code system having approximately 13 thousand traditional Chinese characters, gbk.24 corresponds to the GBK internal code system (simplified Chinese characters), unicode.24 corresponds to the Unicode 2.0 internal code system (11,172 Korean characters), ksc5601.24 corresponds to the ksc5601 internal code system (11,172 Korean characters), and shift-jis.24 corresponds to Shift-JIS Japanese font coding system. Please refer to FIG. 3. FIG. 3 shows a table of all traditional Chinese characters of the big5.24 font file in the BIG5 coding system. As shown in FIG. 3, the BIG coding system uses locations from “A140” (hexadecimal) to “F9FE” for internal codes of each traditional Chinese character. However, the locations might correspond to Chinese characters, specific symbols, or blank characters defined by the user. In FIG. 3, the internal code location of the first Chinese character “ [symbol] ” is “A440”; the internal code location of the second Chinese character “ [symbol] ” is “A441”; the internal code location of the third Chinese character “ [symbol] ” is “A442”, and so on.

In physical contents of files, 72 bytes (72 bytes=24 bits×24 bits) presenting a traditional Chinese character follow a Chinese internal code having 2 bytes, the size of such a Chinese character is shown on the display 300 being 24×24. Therefore, the internal code must be obtained first and then the corresponding character can be accessed according to the internal code.

If the storage medium is the optical disc 200 using a Juliet file system, it can support file names of traditional Chinese characters. As known in the art, other file systems, such as Romeo, UDF, and ISO 9660, can be implemented in optical storage media. The ISO 9660 file system is suitable for each operational system. However, the ISO 9660 file system only supports file names with 8 bits and filename extensions with 3 bits. Information of each file, such as physical locations, directories, and file names, in the storage medium can be obtained by accessing the file system. Moreover, the filename extensions of each font file mentioned above are used for being separated from other types of files. The filename extensions can be changed, and are not limited to the filename extension “24”.

The AV decoding/playing/copying system 100 comprises an optical pickup head 1, a processor 2, a read-only memory (ROM) 3, a dynamic random access memory (DRAM) 4, a controller 5, a video processor 6, a voice processor 7, and an OSD buffer memory 8. The present invention further includes a detector module 9 for detecting the locations of a video source file and an OSD font file (a DBCS file) and for switching the locations of the video source file and the OSD font file when the video source file and the OSD font file stored in several types of storage media are obtained. If the video source file and the DBCS file are stored in the optical disc 200, the processor 2 reads and writes data from the optical disc 200 through the optical pickup head 1. The processor 2 is the control center of the digital decoding system 100, coordinating communications and data transmission of each element, and performing specific functions assigned by the user. The specific functions, for example, are turn-on, turn-off, start the OSD function, and etc.

The ROM 3 stores a plurality of computer program codes for providing the processor 2 to access data in the DRAM 4 to speedily perform specific functions. The ROM 3 includes a file separation module 31 and a character calculation module 32. The file separation module 31 is used for accessing the file system of the storage media 200 and 700 and for distinguishing different filename extensions to access the required file, such as the DBCS file. The character calculation module 32 calculates the physical locations of the required characters in the storage medium according to the DBCS file, and receives the required characters according to the physical locations. The details will be described later.

The processor 2 controls the controller 5, which receives the data of the storage medium 200 by the optical pickup head 1. The data of the storage medium 200, for example, includes an MPEG-2 bit stream of video and voice. The function of the controller 5 is similar to a demux for separating video data and voice data, and outputting video and voice data to the video processor 6 and the voice processor 7, respectively.

The video processor 6 is used for performing MPEG-2 decoding, which includes variable length decode (VLD), inverse quantization, inverse discrete cosine transform (IDCT), and motion compensation. The bit stream is transformed into the original video data by the way mentioned above. Finally, the original video data is coded into NTSC or PAL format and output to the display 300.

What the voice processor 7 does is similar to what the video processor 6 does. After voice signals are decompressed, voice data are transformed from digital into analog and output to a speaker 400 for outputting voice.

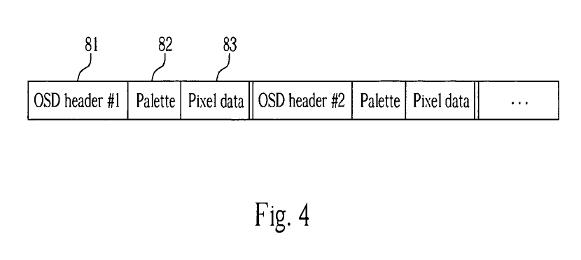

The controller 5 includes an OSD unit 21 for storing OSD information and the specification relative to OSD in the OSD buffer memory 8. Please refer to FIG. 4. OSD information includes a header 81, a palette 82, and pixel data 83. The header 81 records a coordinate of OSD, a function code, and an entry of the palette 82. The function code has OSD display mode with 4 colors, 16 colors, or 256 colors. The palette 82 records brightness and color for each OSD pixel. The pixel data 83 records the color index of each pixel for correctly displaying pixels in a specific region of the display 300.

After the user starts the OSD function, the OSD unit 51 accesses OSD information from the OSD buffer memory 8 in response to the request of the processor 2, and processes specific OSD information according to OSD items (such as a display list) assigned by the user. After that, the OSD unit 51 transmits the processed OSD information into the video processor 6. The processed OSD information overlaps decompressed frames and is transmitted into the display 300 for viewing.

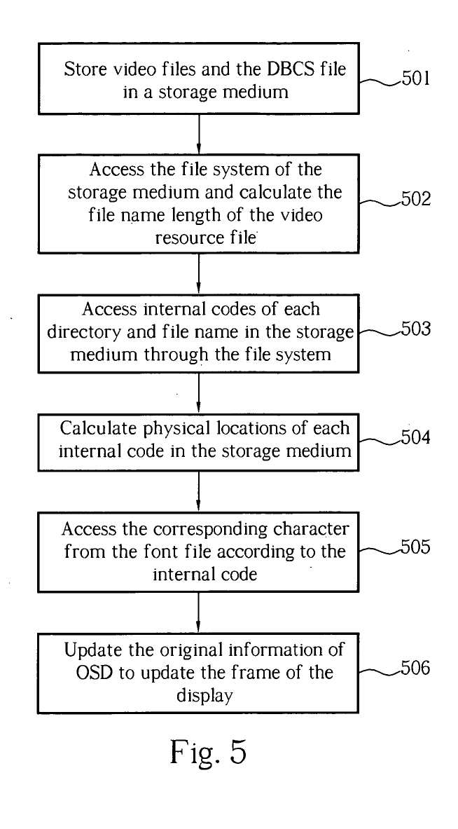

Please refer to FIG. 5, which is a flowchart of the method of the present invention for presenting a DBCS by the OSD function to update the frame of the display. In step 501, DBSC files and video source files are stored in the storage media 200 and 700. The font files must conform to the file system of the storage media 200 and 700. For instance, if directories and file names are recorded with traditional Chinese characters in the storage media 200 and 700, at least one font file is used for storing traditional Chinese characters. The present invention uses five types of font files, big5.24, gbk.24, unicode.24, ksc5601.24, and shift-jis.24, for supporting traditional Chinese, simplified Chinese, Korean, and Japanese. Regarding the time for storing font files in the storage media 200 and 700, font files could be embedded in blank storage media when leaving the factory, or be written while the user writes files in the storage media 200 and 700 by a computer. Due to the size of font files (400 to 1 MB), it occupies an extremely a small part of capacity of the storage media.

In steps 502 and 503, after the user starts the OSD function, the processor 2 accesses the file system of the storage media 200 and 700. Therefore, the OSD unit 51 can receive directory names and file names in the storage media 200 and 700 and calculates the length of the file name of the video source file stored in the storage media 200 and 700.

In step 504, the OSD buffer memory 8 and the ROM 3 do not store traditional Chinese characters, thereby the OSD unit 51 captures corresponding characters from the font files of the storage media 200 and 700 according to the internal codes of the file name mentioned above. The processor 2 acquires all files with filename extension “24”, from the file separation module 31 thereby supporting at least five internal code systems, BIG-5 (traditional Chinese), GBK (simplified Chinese), Unicode 2.0 (Korean), ksc5601 (Korean), and Shift-JIS (Japanese).

Which DBCS file provides characters can be automatically detected by the processor 2 or assigned by the user. As mentioned above, 72 bytes (72 bytes=24 bits×24 bits) presenting a traditional Chinese character follows a Chinese internal code having 2 bytes. In other words, the physical location of the internal code shifts 72 bytes after the former internal code. Although the internal code of the required character is obtained, the total shifting bytes of the required character must be calculated in order to add the total offset after the physical location of the internal code for acquiring the physical location of the required character.

Internal codes defined in each internal code system are different thereby the calculations of total offset are different. The following will describe programs for calculating total offsets for each font file of the embodiment of the present invention.

(1) Traditional Chinese (BIG5):

```
Set Code  /* set an internal code */
Set Code1 ,Code2
  /* set high and low bytes of the internal code */
Set i, j  /* set temporary values */
Set Total-Offset /* set the total offset */
If (Code≧0xA140&&Code≦0xF9FE)
  /* determine whether the internal code is located
  within the region from 0xA140 to 0xF9FE */
{
  code1=(Code & 0xFF00)>>8;
    /*acquire the high byte of the internal code */
  code2=(Code & 0xFF);
    /* acquire the low byte of the internal code */
  i=(code1−0xA1);
    /* calculate the high byte difference of the
      internal code and the beginning code */
  j=(code2−0x40);
    /* calculate the low byte difference of the
      internal code and the beginning code */
  if(code2 > 0XA0) j=j−34;
    /* due to 34 locations with null characters from
      0x7F to 0xA, subtract 34 from the low byte
      difference of the internal code and the
      beginning code so as to ignore the blank code
      locations */
  Total-Offset=2+(i×(12×16−35)×74)+(j×72)+(j×2);
    /* subtract a value of quantities of blank code
      locations from the high and low byte
      differences of the internal code and the
      beginning code, and calculate the total
      offset by adding the number (72 bytes) of font
      bytes to the number (2 bytes) of bytes of
      double byte character */
}
```

For instance, the BIG 5 traditional Chinese coding system utilizes 0xA140 to 0xF9FF. Therefore, the beginning code is 0xA140 and the end code is 0xF9FF. First, the present invention sets all calculation parameters and temporary values, and determines whether the internal code of the required character is located in the code range of the BIG 5 traditional Chinese coding system. If yes, the high and low bytes of the internal code are captured. Then the high and low byte differences of the internal code and the beginning code are respectively calculated. Next, due to 34 locations with null characters from 0x7F to 0xA0, subtract 34 from the low byte difference of the internal code and the beginning code to ignore the blank code locations. Finally, subtract a value of quantities of blank code locations from the high and low byte differences of the internal code and the beginning code, and calculate the physical location of the required double byte character in the storage medium by adding the number of font bytes to the number of bytes of double byte character.

Take “ [symbol] ” character for example. The high byte of the internal code is “A4”, the former two internal codes, and the low byte is “40”, the latter two internal codes. The calculation is performed according to the beginning location “A140” and the end location “F9FE” to calculate the total offset thereby the physical locations of each character can be acquired. The following calculations in different internal code systems are similar.

(2) Simplified Chinese (GBK):

```
Set Code
Set Code1, Code2
Set i, j
Set Total-Offset
If (Code≧0x8140&&Code≦0xFEFF)
  /* determine whether the internal code is located
    within the region from 0x8140 to 0xFEFF */
{
  code1=(Code & 0xFF00)>>8;
    /* acquire the high byte of the internal code */
  code2=(Code & 0xFF);
    /* acquire the low byte of the internal code */
  i=(code1−0x81);
    /* calculate the high byte difference of the
      internal code and the beginning code */
  j=(code2−0x40);
    /* calculate the low byte difference of the
      internal code and the beginning code */
    if(code2 > 0x7F) j=j−1;
    /* due to the 0x7F location with null character,
    subtract 1 from the low byte difference of the
    internal code and the beginning code so as to
    ignore the blank code location */
  Total-Offset=2+(i×(12×(16−2)×74)+(j×72)+(j×2);
    /* subtract a value of quantities of blank code
      locations from the high and low byte
      differences of the internal code and the
      beginning code, and calculate the total offset
      by adding the number (72 bytes) of font bytes
      to the number (2 bytes) of bytes of double byte
      character */
}
```

(3) Korean (Unicode 2.0):

```
Set Code
Set Code1, Code2
Set i, j
Set Total-Offset
If (Code≧0xAC00&&Code≦0xD7A3)
  /* determine whether the internal code is located
    within the region from 0xAC00 to 0xD7A3 */
{
  code1=(Code & 0xFF00)>>8;
    /* acquire the high byte of the internal code */
  code2=(Code & 0xFF);
    /* acquire the low byte of the internal code */
  i=(code1−0xAC);
    /* calculate the high byte difference of the
      internal code and the beginning code */
  j=(code2−0x00);
    /* calculate the low byte difference of the
      internal code and the beginning code */
  Total-Offset=2+(i×(16×16)×74)+(j×72)+(j×2);}°
    /* subtract a value of quantities of blank code
      locations from the high and low byte
      differences of the internal code and the
      beginning code, and calculate the total offset
      by adding the number (72 bytes) of font bytes
      to the number (2 bytes) of bytes of double byte
      character */
}
```

(4) Korean (Johab/KSCO5601-1992):

```
Set Code
Set Code1, Code2
Set i, j, k, m, n, p
Set Total-Offset
If (Code≧0x8861&&Code≦0xD3BD)
{
  code1=(Code & 0xFF00)>>8;
  code2=(Code & 0xFF);
  i=(code1−0x88);
  m=(i%4);
  k=(i>>2)
  j=(code−0x8860)−(k×1024);
  n=(j+32)−(2×m);
  p=code2 >>4;
  q=(code2 & 0xf)
  if ((p%2)!=0)
  {
    if (q>2)
      Total-Offset=2+[(k×588)+(j−2−(m×64)−(n×
        4))]×74;
    else
      Total-Offset=2+[(k×588)+(j−1−(m×64)−(n×
        4))]×74;
  }
  else
    Total-Offset=2+[(k×588)+(j−1−(m×64)−(n×4))]×
      74;
}
```

(5) Japanese (Shift-JIS):

```
(A) If (Code ≧ 0x889F && Code ≦ 0x9872)
  /* determine whether the internal code is located
  within the region from 0x889F to 0x9872 */
  {
  code1=(Code & 0xFF00)>>8;
    /*acquire the high byte of the internal code */
  code2=(Code & 0xFF);
    /* acquire the low byte of the internal code */
  i=(code1−0x88);
    /* calculate the high byte difference of the
    internal code and the beginning code */
  j=(code2−0x40);
    /* if the internal code is located in the region
    from 0x8940 to 0x9872, calculate the low byte
    difference of the internal code and the
    beginning code of the region */
  if ( i == 0 )
    /* the internal code range is from 0x889F to
    0x88FC */
    k = ( code2 − 0x9F );
      /* calculate the offset of the internal code
        of the beginning code */
  else
    /* the internal code range is from 0x8940 to
    0x9872 */
    {
    if ( code2 > 0x7F )
      k = 94 + ( i − 1 ) × (10 × 16 + 15 + 13 )
        + ( j − 1 );
        /* calculate the offset of the internal code
        of the beginning code */
    else
      k = 94 + ( i − 1 ) × (10 × 16 + 15 + 13 )
        + j;
        /* calculate the offset of the internal code
        of the beginning code */
    }
    Total-Offset = 2 + ( k × 74 );
    /* calculate the total offset according to the
      sum of the number (72 bytes) of font bytes and
      the number (2 bytes) of bytes of double byte
      character, and according to the offset of the
      internal code and the beginning code */
  }
(B) If (Code ≧ 0x989F && Code ≦ 0x9FFC)
  /* determine whether the internal code is located
  within the region from 0x989F to 0x9FFC */
  {
  code1=(Code & 0xFF00)>>8;
    /* acquire the high byte of the internal code */
  code2=(Code & 0xFF);
    /* acquire the low byte of the internal code */
  i=(code1−0x98);
    /* calculate the high byte difference of the
    internal code and the beginning code */
  j=(code2−0x40);
    /* if the internal code is located in the region
    from 0x9940 to 0x9FFC, calculate the low byte
    difference of the internal code and the beginning
    code of the region */
  if ( i == 0 )
      /* the internal code range is from the internal
      code range is from 0x989F to 0x98FC */
    k = 2965 + ( code2 − 0x9F );
      /* 2965 is derived from part (A): 0x9872 is
      input into the part (A) to get the offset of
      0x889F ˜0x9872 */
  else
    /* the internal code range is from the internal
    code range is from 0x9940 to 0x9FFC */
    {
      if ( code2 > 0x7F )
        k = 2965 + 94 + ( i − 1 ) × (10 × 16 + 15
          + 13 ) + ( j − 1 );
          /* calculate the total offset according to
          the sum of the number (72 bytes) of font
          bytes and the number (2 bytes) of bytes of
          double byte character, and according to the
          offset of the internal code and the
          beginning code */
      else
        k = 2965 + 94 + ( i − 1 ) × (10 × 16 + 15
        + 13 ) + j;
    }
      /* calculate the offset of the internal code and
      the beginning code */
  Total-Offset = 2 + ( k × 74 );
      /* 74= 2 (2 bytes for DBCS)+ 72 (72 bytes for
      font file) =74 (bytes) */
      /* calculate the total offset according to the
      sum of the number (72 bytes) of font bytes and
      the number (2 bytes) of bytes of double byte
      character, and according to the offset of the
      internal code and the beginning code */
  }
(C) If (Code ≧ 0xE040 && Code ≦ 0xEAA2)
    /* determine whether the internal code is located
    within the region from 0xE040 to 0xEAA2 */
  {
  code1=(Code & 0xFF00)>>8;
    /* acquire the high byte of the internal code */
  code2=(Code & 0xFF);
    /* acquire the low byte of the internal code */
  i=(code1−0xE0);
    /* calculate the high byte difference of the
    internal code and the beginning code */
  j=(code2−0x40);
    /* calculate the low byte difference of the
    internal code and the beginning code */
  if ( code2 > 0x7F )
    k = 4375 + i × (10 × 16 + 15 + 13 ) + ( j − 1 );
      /* 4375 is derived from part (2): 0x9FFC is input
      into the part (2) to get the offset of 0x889F
      ˜0x9FFC */
  else
    k = 4375 + i × (10 × 16 + 15 + 13 ) + j;
      /* calculate the offset of the internal code and
      the beginning code */
  Total-Offset = 2 + k × 74;
      /* calculate the total offset according to the
      sum of the number (72 bytes) of font bytes and
      the number (2 bytes) of bytes of double byte
      character, and according to the offset of the
      internal code and the beginning code */
}
```

In steps 505 and 506, after acquiring the physical locations of the required characters, the character data is received from the font file. After that, the OSD unit 51 chooses which pixels of a frame to present a character with specific colors according to the OSD information of the OSD buffer memory 8. Therefore, the present invention can update the original OSD information and present the character on the display 300.

In conclusion, the present invention stores font files in the storage media so that no additional memory is needed to store all types of fonts. No matter which file system of DBCS internal code system is used, offsets for each character can be correctly calculated. The characters corresponding to internal codes are obtained from the storage media and correctly presented on the display. Therefore, the present invention makes it convenient for the user to manage and play the files stored in the storage media by the OSD function.

Those skilled in the art will readily observe that numerous modifications and alterations of the device and method may be made while retaining the teachings of the invention. Accordingly, the above disclosure should be construed as limited only by the metes and bounds of the appended claims.

1. A method for presenting a double byte character on a display device of an AV decoding/playing/copying system to update a frame of the display device, the method comprising:
(a) storing a double byte character set (DBCS) file and a video source file in a storage medium;
(b) accessing the file system information of the storage medium and calculating the length of a file name of the video source file;
(c) accessing the required double byte character from the DBCS file; and
(d) updating the original information of an on-screen display (OSD) to update a frame of the display device according to the received double byte character.

2. The method of claim 1 wherein the storage medium is an optical disc or a memory card.

3. The method of claim 1 wherein step (c) further comprises:
(c1) calculating a physical location of the required double byte character in the storage medium; and
(c2) capturing the required double byte character from the physical location.

4. The method of claim 3 wherein the DBCS file is BIG5 internal code system, gbk internal code system, or Unicode Korean internal code system, and step (c1) is achieved by the following steps:
calculating high and low byte differences of the internal code of the required double byte character and the beginning code of the file of DBCS; and
subtracting a value of quantities of blank code locations from the high and low byte differences, and calculating the physical location of the required double byte character in the storage medium by adding the number of font bytes to the number of bytes of the double byte character.

5. The method of claim 3 wherein the file of a double byte character set is Shift-JIS internal code system, and step (c1) is achieved by the following steps:
if the internal code of the required double byte character is located within a first section of the internal code system, calculating the high byte difference of the internal code of the required double byte character and the beginning internal code of the first section, calculating the low byte difference of the internal code of the required double byte character and the beginning internal code of the first section, subtracting a value of quantities of blank code locations from the high and low byte differences, and calculating the physical location of the required double byte character in the storage medium by adding the number of font bytes to the number of bytes of the double byte character;
if the internal code of the required double byte character is located within a second section of the internal code system, calculating the high byte difference of the internal code of the required double byte character and the beginning internal code of the second section, calculating the low byte difference of the internal code of the required double byte character and the beginning internal code of the second section, subtracting a value of quantities of blank code locations and the number of bytes of codes in the first section from the high and low byte differences, and calculating the physical location of the required double byte character in the storage medium by adding the number of font bytes to the number of bytes of the double byte character; and
if the internal code of the required double byte character is located within a third section of the internal code system, calculating the high byte difference of the internal code of the required double byte character and the beginning internal code of the third section, calculating the low byte difference of the internal code of the required double byte character and the beginning internal code of the third section, subtracting a value of quantities of blank code locations and the numbers of bytes of codes in the first and second sections from the high and low byte differences, and calculating the physical location of the required double byte character in the storage medium by adding the number of font bytes to the number of bytes of the double byte character;

6. The method of claim 1 wherein the video source file is an MP3 (MPEG layer 3) file.

7. An AV decoding/playing/copying system that presents a double byte character on a display device by an on-screen display function to update a frame of the display device, the AV decoding/playing/copying system comprising:
a storage medium for storing a video source file and at least one type of double byte character set file;
an on-screen display (OSD) buffer memory for storing OSD information;
a memory;
a processor electrically connected to the memory, the process capable of accessing a file system of the storage medium and temporarily storing an internal code of a file name in the memory; and
an on-screen display unit electrically connected to the OSD buffer memory, the on-screen display unit capable of capturing a required double byte character from the double byte character set file through the processor according to the internal code of the file name temporarily stored in the memory, and presenting the required double byte character on the display device according to the OSD information to update the frame of the display device.

8. The AV decoding/playing/copying system of claim 7 wherein the processor further including a file separation module for separating the double byte-character set file from the file system of the storage medium in order to access the double byte character.

9. The AV decoding/playing/copying system of claim 7 wherein the processor further including a character calculation module for calculating location offsets of each character corresponding to internal codes according to a beginning location and an end location defined by the double byte character set file to obtain the physical location of each character.

10. The AV decoding/playing/copying system of claim 7 wherein the storage medium is an optical disc or a memory card.

11. The AV decoding/playing/copying system of claim 7 further comprising a detector module for detecting the locations of the video source file and the double byte character set file and for switching the locations of the video source file and the double byte character set file when the video source file and the double byte character set file stored in several types of storage media are obtained.

12. The AV decoding/playing/copying system of claim 7 wherein the video source file is an MP3 file.
